(19) United States
(12) Patent Application Publication
(10) Pub. No.: US 2005/0145316 A1
(43) Pub. Date: Jul. 7, 2005

(54) Attaching dissimilar materials to a fuel tank by weldment

(75) Inventors: Robert P. Benjey, Dexter, MI (US); Maxim V. Zorine, Ann Arbor, MI (US); Analis R. Quintman, Ann Arbor, MI (US)

Correspondence Address: EATON CORPORATION;EATON CENTER, 1111 SUPERIOR AVENUE, CLEVELAND, OH, 44114, US

(73) Assignee: EATON CORPORATION, Cleveland, OH (US)

(21) Appl. No.: 10/751,375

(22) Filed: Jan. 5, 2004

(51) Int. Cl. B32B 31/16; B29C 65/06; F16K 24/00

(52) U.S. Cl. 156/73.5; 156/73.1; 137/587

(57) ABSTRACT

A pass-through formed of material unweldable to a non-metallic tank has an adaptor ring formed of material also unweldable to the tank which is welded to the pass-through body. Prior to welding the adaptor ring to the pass-through the adaptor ring is chemically bonded to a mounting ring, which is formed of material weldable to the tank. The assembly thus formed may then be welded to the tank.

### BACKGROUND OF THE INVENTION

The present invention relates to attaching pass-through or flow-through devices to a fuel tank and particularly relates to such attachments to fuel tanks formed of non-metallic material. Currently, in the mass production of fuel tanks for passenger vehicles and light trucks, a substantial percentage of the production tanks are formed of non-metallic material as, for example, polyethylene material and particularly high density polyethylene (HDPE). Such tanks may also include a fuel vapor impervious barrier layer molded therein to reduce the permeation of fuel vapor into the atmosphere as required by recently mandated fuel vapor emission standards.

Where it is required to attach a pass-through or flow-through device through the fuel tank wall, such as a filler tube spud or fuel vapor vent control valve, it has been found advantageous to attach the pass-through device to the tank wall by weldment, for example, by spin welding, hot plate welding or sonic welding.

However, it has been found undesirable to form the pass-through devices of the same material as the fuel tank in order to facilitate manufacturing of the device and provide the necessary structural integrity and robustness required for a device. Accordingly it has been desirable to find a way or means of forming the pass-through device of a different material than the wall of a non-metallic fuel tank and which is unweldable to the tank and yet to provide for attachment to the tank by weldment.

### BRIEF SUMMARY OF THE INVENTION

The present invention provides a novel and cost effective technique for facilitating attachment of a pass-through device through a fuel tank wall by weldment where the pass-through device is formed of material unweldable to the fuel tank. The present invention is particularly suitable for attachment of a pass-through device by weldment to a fuel tank formed of HDPE.

The body of the pass-through device such as the tube of a filler spud or the body of a fuel vapor vent control valve is formed of material unweldable to the tank, as for example, polyamide material; and, a mounting ring formed of material such as HDPE weldable to the tank is chemically bonded to an adaptor ring, preferably by overmolding. The adaptor ring is attached to the body of the pass-through by weldment, preferably spin welding, and the assembly of the mounting ring, adaptor ring and pass-through body is subsequently attached to the wall of the tank by weldment. The technique of the present invention thus facilitates attachment of a pass-through formed of material unweldable to a tank to the wall of a non-metallic fuel tank by weldment.

### BRIEF DESCRIPTION OF THE DRAWINGS

FIG. 1 is a cross-section of the invention as embodied for attachment of a fuel vapor vent valve to the wall of a fuel tank; and,

FIG. 2 is a cross-section of the invention embodied in the attachment of a filler tube spud through the wall of a non-metallic fuel tank.

### DETAILED DESCRIPTION OF THE INVENTION

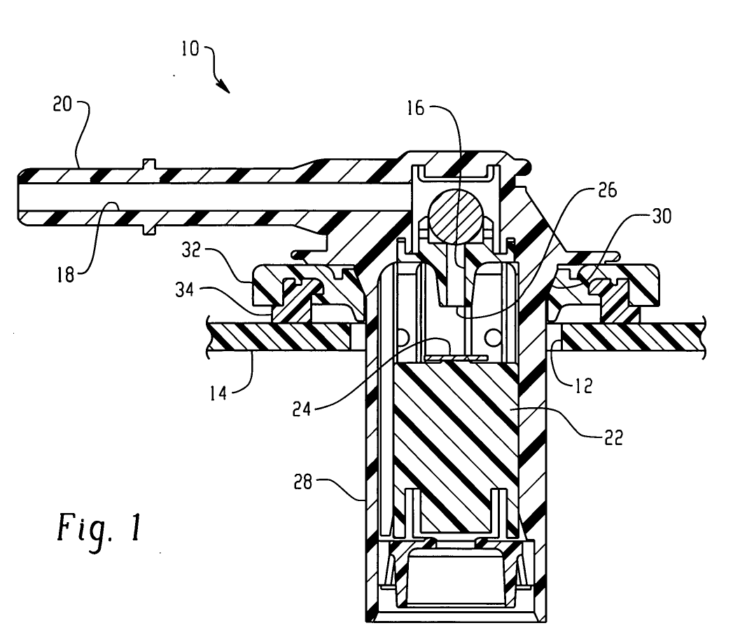

Referring to FIG. 1, a fuel vapor vent valve indicated generally at 10 is shown installed through an access opening 12 formed in the wall 14 of a non-metallic fuel tank. Valve 10 includes a vent passage 16 which communicates through passage 18 formed in a fitting 20 to the exterior of the tank. Valve 10 includes a float 22 having a valve member 24 provided thereon which is operable to close against a valve seat 26 for controlling flow-through the passage 16. The valve 10 includes a body 28 having the fitting 20 formed therewith of suitable material for structural integrity and robustness as, for example, polyamide or glass filled polyamide material. It will be understood however, that other suitable non-metallic materials may be used; and, that the body 28 and fitting 20 are preferably integrally formed by molding. The valve body 28 has an annular preferably tapered surface 30 formed thereon to which is secured an adaptor ring 32 such as by weldment and preferably spin welding.

Adaptor ring 32 has chemically bonded thereto a mounting ring 34 formed of material weldable to the tank wall 14 such as, for example but not limited to, HDPE material; and, the ring 34 has portions thereof extending outwardly of the surface of the adaptor ring 32. In the presently preferred practice of the invention, the mounting ring 34 is overmolded by adaptor ring 32 and this may be accomplished by insert molding. In the presently preferred practice of the invention mounting ring 34 may be formed of material comprising a mixture in the range of about one-tenth to four percent (0.1%-4% by weight Maleic anhydride balance polyethylene and preferably balance HDPE with a melt index of 7 to 10 per ASTM D-1238 using HLMI; however, low density polyethylene or other suitable material may also be used. The Maleic anhydride serves to facilitate chemical bonding with the adaptor ring.

The arrangement of FIG. 1 thus embodies the invention in a manner which enables the attachment of a fuel vapor vent valve having a body formed of material unweldable to the tank wall to be installed over an access opening in the wall of the tank and secured thereon by weldment.

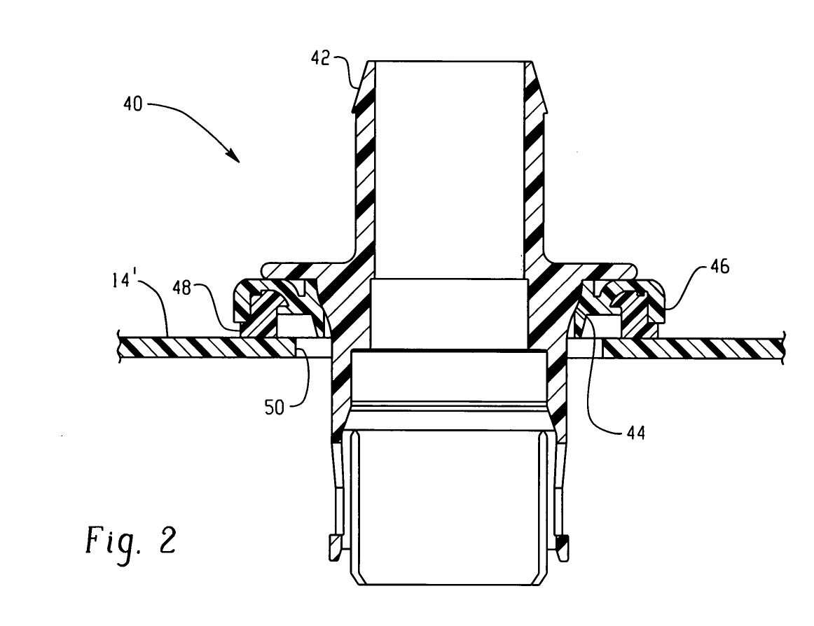

Referring to FIG. 2 another embodiment of the invention is illustrated generally at 40 where a pass-through device in the form of a filler tube spud 42 has an annular tapered portion 44 formed about the outer periphery thereof which has secured thereto by weldment an adaptor ring 46 formed of material weldable to the body 42 as, for example but not limited to, polyamide or glass-filled polyamide. The adaptor ring 46 has chemically bonded thereto a mounting ring 48 formed of material compatible for weldment with a wall 14′ of a non-metallic fuel tank and may be formed of HDPE material or other suitable material weldable to the tank and as described above with reference to ring 34. In the presently preferred practice of the invention, mounting ring 48 is overmolded by the adaptor ring 46 by any suitable technique as, for example, insert molding with portions of the ring 48 extending exteriorly of adaptor ring 46.

The subassembly of the spud or body 42, adaptor ring 46 and mounting ring 48 is then attached over the access opening 50 in the tank wall by weldment of the mounting ring 48 to the outer surface of tank wall 14′ by any suitable welding technique as, for example, spin welding, hot plate welding or ultra sonic welding. Thus, the embodiment of FIG. 2 provides a simple and low cost yet effective way of attaching a filler tube spud to a non-metallic fuel tank by weldment where the spud is formed of material unweldable to the tank.

Although the invention has hereinabove been described with respect to the illustrated embodiments, it will be understood that the invention is capable of modification and variation and is limited only by the following claims.

1. A method of making a weldable attachment for a non-metallic fuel tank comprising:
(a) forming a body member of material non-weldable to the tank with a passage therethrough for flow in the passage upon attachment of the valve to the tank;
(b) forming an annular mounting member of material weldable to the tank;
(c) forming an annular adaptor member of material weldable to the body and chemically bonding said adaptor member to said mounting member; and,
(d) attaching said adaptor member to said body member by weldment.

2. The method defined in claim 1, wherein said step of attaching the annular adaptor includes spin welding.

3. The method defined in claim 1, wherein said step of forming an annular adaptor includes forming an adaptor of polyamide material.

4. The method defined in claim 1, wherein said step of forming an annular mounting includes forming the mounting member of material comprising a mixture in the range of about one-tenth to four percent (0.1-4%) by weight Maleic anhydride balance Polyethylene.

5. The method defined in claim 1, wherein said step of attaching includes forming an annular tapered surface on said body and a corresponding annular tapered surface on said adaptor.

6. The method defined in claim 1, wherein said step of chemically bonding includes overmolding.

7. The method defined in claim 6, wherein said step of chemically bonding includes two-shot molding.

8. The method defined in claim 1, wherein said step of forming a body comprises forming a body of unreinforced polyamide.

9. The method defined in claim 1, wherein said step of forming an annular adaptor comprises forming an adaptor of unreinforced polyamide.

10. The method defined in claim 1, wherein said step of forming a mounting member includes forming of material comprising a mixture in the range of about one-tenth to four percent (0.1-4%) by weight Maleic anhydride balance HDPE with a melt index of 7 to 10 per ASTM D-1238 using HLMI.

11. The method defined in claim 1, wherein said step of forming a mounting member includes forming material comprising a mixture in the range of about one-tenth to four percent (0.1-4%) by weight Maleic anhydride balance linear low density Polyethylene.

12. The method defined in claim 1, further comprising inserting said body in an access opening in the tank and welding said mounting member to the tank.

13. An assembly adapted for attachment to a non-metallic fuel tank comprising:
(a) a body member formed of material unweldable to the tank and defining a flow passage therethrough;
(b) a mounting ring formed of material weldable to the tank; and,
(c) an adaptor ring formed of material weldable to the body member, said adaptor ring chemically bonded to said mounting ring, wherein said adaptor ring is attached to said body member by weldment.

14. The assembly defined in claim 13, wherein said mounting ring is bonded by overmolding said adaptor ring.

15. The assembly defined in claim 13, wherein said mounting ring and said adaptor ring are bonded by two-shot molding.

16. The assembly defined in claim 13, wherein said body member and adaptor ring are formed of polyamide material and said mounting ring is formed of a material comprising a mixture in the range of about one-tenth to four percent (0.1-4%) by weight Maleic anhydride, balance HDPE.

17. The assembly defined in claim 13, wherein said body member is formed of unreinforced polyamide material.

18. The assembly defined in claim 13, wherein said adaptor ring is attached to said body by spin welding.

19. The assembly defined in claim 13, wherein said mounting ring is formed of material comprising a mixture in the range of about one-tenth to four percent (0.1—4%) Maleic anhydride balance HDPE with a melt index of 7 to 10 per ASTM D-1238 using HLMI.

20. The assembly defined in claim 13, wherein said mounting ring is formed of material comprising a mixture in the range of about one-tenth to four percent (0.1-4%) Maleic anhydride balance linear low density Polyethylene.

21. An assembly of a fuel tank and a flow-through attachment comprising:
(a) a body member formed of material unweldable to the tank and defining a flow passage therethrough;
(b) a mounting ring formed of material weldable to the tank;
(c) an adaptor ring formed of material weldable to the body member, said adaptor ring chemically bonded to said mounting ring, wherein said adaptor ring is attached to said body member by weldment; and,
(d) said tank has an access opening with said mounting attached thereover by weldment and said flow passage communicating through said access opening.
